(19) United States
(12) Patent Application Publication
(10) Pub. No.: US 2013/0312583 A1
(43) Pub. Date: Nov. 28, 2013

(54) VIBRATION PLATE FOR MUSIC BOX AND PREPARATION METHOD THEREOF

(71) Applicant: Gyu Lak Han, Yongin-si (KR)

(72) Inventor: Gyu Lak Han, Yongin-si (KR)

(21) Appl. No.: 13/820,512

(22) PCT Filed: Feb. 9, 2012
(86) PCT No.: PCT/KR12/00976

§ 371 Date: Mar. 3, 2013

(30) Foreign Application Priority Data
Feb. 18, 2011 (KR) 10-2011-0014364

(51) Int. Cl. G10F 5/04

(52) U.S. Cl. CPC G10F 5/04
USPC 84/115; 29/896.22

(57) ABSTRACT

The present invention is an music box vibration plate and the Preparation method thereof, which comprises of a plurality of vibration piece disposed in parallel and having a thin flat sound generation pin with different length and generating sound as it is hit by the protrusion of the cylindrical drum or the disc and a fixing portions formed at the base end of the sound generation pin and having an enlarged thickness with the shape of plate, and a plurality of spacer disposed between each fixing portions of the vibration pieces to separate the vibration pieces, and a clamping member to clamp the fixing portions and the spacers.

### TECHNICAL FIELD

The present invention relates to a vibration plate for music box and the preparation method thereof, and more particularly to a vibration plate for music box being able to achieve a precise sound scale so as to play music with the precise sound scale and the preparation method thereof.

### BACKGROUND ART

Usually, a music box, or an orgel is referred to an automatically played music instrument toy and is applied to clock, finger ring, neck lace, toy and so on. There are two types of music box, the first type music box comprises a disc having a plurality of protrusions cut and bent with predetermined pattern on one side and a metal bar traversing the surface of the disc and having a plurality of pins extending downward against the disc. When the disc turns, the protrusions of the disc hit the pins of the metal bar to generate the sound.

The second type music box comprises, as the basic parts, a rotating cylindrical drum 1 and a metal vibration plate 3 disposed at the side of the cylindrical drum 1 as shown in FIG. 1. The cylindrical drum 1 has a plurality of protrusions 2 with the predetermined pattern on the circumferential surface of it, and the vibration plate 3 has a plurality of sound generation pins 5 with the different lengths corresponding to the different sounds of scale. When the protrusions 2 hit the sound generation pins 5 of the vibration plate 3, the sound generation pins 5 may vibrate and generate the corresponding sounds.

To make the vibration plate 3 having the sound generation pins 5, the metal plate should go through the slit-cutting process to form the sound generation pins 5 with different length. To do this, the metal plate should be machined for the sound generation pins 5 to be formed on the base 4 of the vibration plate 3 in parallel. And the metal plate should be machined for the thickness of the sound generation pins 5 to be thinner than that of the base 4, and the lengths of the sound generation pins 5 to be different from each other corresponding to the sound scale.

The sound generation pin 5 has a natural frequency according to the length of it, and a little difference of the length may result in the difference of the sound. In general, in consideration of the convenience of machining and productivity, the front end of the base 4 of the vibration plate 3 is machined to form an inclined line. But, this process of machining could not achieve precise dimension of the sound generation pins 5 because the lengths of them are machined in one time. So the vibration plate 3 of the conventional music box could not achieve a precise scale of sound.

### DISCLOSURE

### Technical Problem

In order to solve the above-mentioned problems of conventional art, it is an object of the present invention to provide a music box vibration plate being able to achieve a precise sound scale so as to play music with the precise sound scale and the preparation method thereof.

### Technical Solution

To attain the above object of the present invention, according to an aspect of the present invention, there is provided an music box vibration plate disposed adjacent to the circumferential surface of a cylindrical drum 1 having a plurality of protrusions 2 on the circumferential surface of it and generating sound as it is hit by the protrusions 2 of the cylindrical drum 1, wherein the vibration plate 10 comprises of a plurality of vibration piece 20 disposed in parallel and having a thin flat sound generation pin 21 with different length and generating sound as it is hit by the protrusion 2 of the cylindrical drum 1 and a fixing portions 22 formed at the base end of the sound generation pin 21 and having an enlarged thickness with the shape of plate, and a plurality of spacer 30 disposed between each fixing portions 22 of the vibration pieces 20 to separate the vibration pieces 20, and a clamping member to clamp the fixing portions 22, and the spacers 30.

According to another aspect of the present invention, there is provided an music box vibration plate, wherein the clamping member comprises a tie rod 41, and there are holes 31 in the fixing portions 22 of the vibration pieces 20 and the spacers 30 aligned with each other, and the tie rod 41 passes through the hole 31.

According to still another aspect of the present invention, there is provided an music box vibration plate, wherein the clamping member comprises a clamping block 42 on which the spacers 30 are formed in a body, and the fixing portions 22 of the vibration pieces 20 are inserted between the spacers 30.

According to another aspect of the present invention, there is provided a preparation method of a vibration plate for music box disposed adjacent to the circumferential surface of a cylindrical drum 1 having a plurality of protrusions 2 on the circumferential surface of it and generating sound as it is hit by the protrusions 2 of the cylindrical drum 1, wherein the method comprises of:

making the vibration piece 20 having a thin flat sound generation pin 21 and a fixing portions 22 formed at the base end of the sound generation pin 21 and having an enlarged thickness with the shape of plate by partially cutting the stack of a plurality of metal bars;

choosing a set of vibration piece 20 having the sound generation pin 21 with different length and arraying them to form the sound scale and inserting the spacers 30 between each fixing portions 22 of the vibration piece 20; and

clamping all the fixing portions 22 of the vibration pieces 20 and the spacers 20 by use of a clamping member 41, 42.

### Advantageous Effects

According to the present invention, by making the vibration piece 20 having the sound generation pin 21 with different length separately and assembling them, the sound generation pin 21 with the same dimension and the same natural frequency can be obtained at the same time, so the dimension of the sound generation pin 21 such as the length and the thickness can be machined more precisely to achieve more precise sound scale compared to the conventional vibration plates of music box in which the sound generation pins are formed by slitting the metal plate and cutting in different length at once, so the machining process is complicate and low in precision degree.

And according to the present invention, by making the vibration piece 20 having a thin flat sound generation pin 21 and a fixing portions 22 formed at the base end of the sound generation pin 21 and having an enlarged thickness with the shape of plate by partially cutting the stack of a plurality of metal bars; a lot of vibration bar 20 could be machined to have the same dimension at the same time to achieve a precise sound scale and high productivity.

### DESCRIPTION OF THE DRAWINGS

The above and other objects and advantages of the invention will become more apparent by describing a preferred embodiment with reference to the accompanying drawings in which:

FIG. 1 is a schematic view of the conventional vibration plate of music box;

FIG. 2 is a perspective view of an embodiment of the vibration plate of music box according to the present invention;

FIG. 3 and FIG. 4 are the views showing the process of the method of the invention;

FIG. 5 is a perspective view of another embodiment according to the invention.

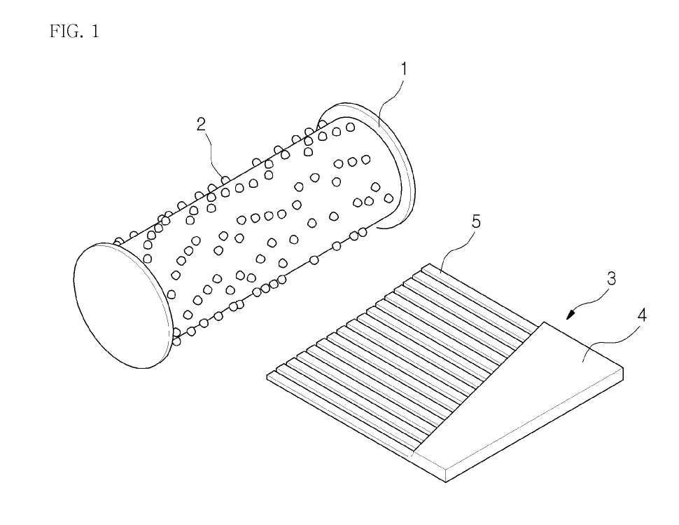

### BEST MODE

Hereinbelow, the preferred embodiments of the invention will be described with reference to the accompanying drawings.

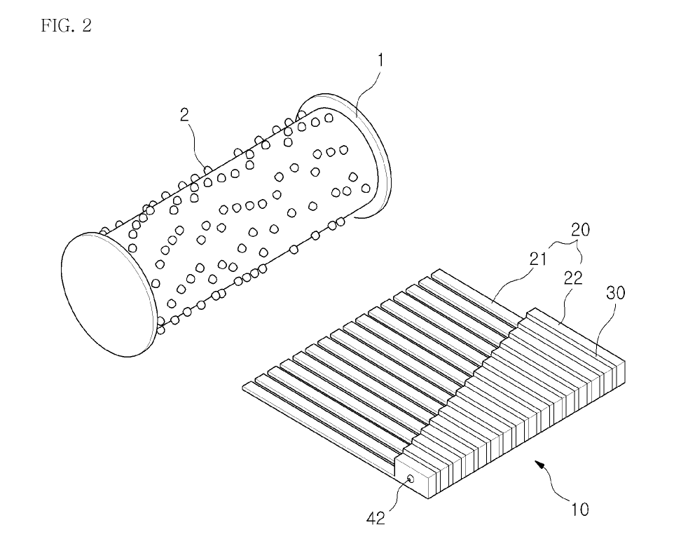

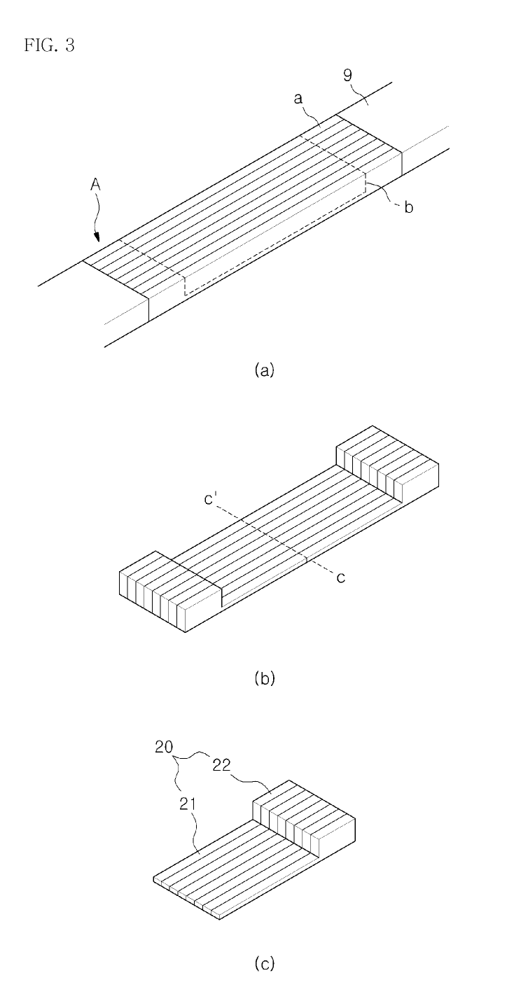

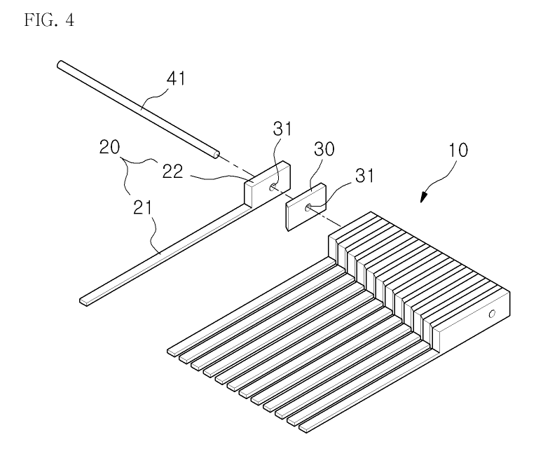

Referring to FIG. 2, FIG. 3 to 4, a vibration plate 10 for music box of the invention is disposed adjacent to the circumferential surface of the cylindrical drum 1 having a plurality of protrusions on the circumferential surface of it. The vibration plate 10 comprises a plurality of vibration bar 20 disposed in parallel and having a thin flat sound generation pin 21 with different length and generating the sound as it is hit by the protrusions 2 of the cylindrical drum 1 and a fixing portions 22 formed at the base end of the sound generation pin 21 and having an enlarged thickness with the shape of plate, and a plurality of spacer 20 disposed between the each fixing portions 22 of the vibration pieces 20 to separate each vibration piece 20, and a clamping member 41, 44 to clamping the fixing portions 22 and the spacers 30 in one body.

Referring FIGS. 3 and 4, the preparation process of the vibration plate of music box is explained. As shown in FIG. 3A, a plurality of long rectangular metal plate (a) with short vertical length and long horizontal length are stacked to form a metal bar stack (A). The metal bar stack (A) is placed in the frame 9. And the inner part of metal bar stack (A) is cut according to the cutting line (b) in the shape of rectangular as shown in FIG. 3. Then the lower part of the cutting line (b) is formed as thin and flat. The cutting line (b) may be cut by press, wire cutting, laser cutting, water-jet cutting or other proper cutting means.

Then the resulted metal bar stack (A) is shaped as shown in FIG. 3. After this, the metal bar stack (A) is cut along the traversing direction of each metal bar (a) at the central part of the cut thin flat portion according the line c-c in FIG. 3(b). Then a pair of L shaped metal bar stacks are obtained as shown in FIG. 3(c). As a result, a plurality of L shape vibration piece 20 having thin flat sound generation pin 21 formed by cutting and the non-cut fixing portions 22 with the enlarged thickness. As the sound generation pins 21 are machined through the same cutting process, the length and thickness of them are almost the same, so the natural frequencies and the sounds of the sound generation pins 21 are almost same to each other.

If the position of the cutting line (b) is adjusted, different metal bar stacks (A) with the different length of sound generation pin 21 could be obtained. So the vibration pieces 20 of different sound generation pin 21 will generate different sound according to their natural frequencies as they are hit by the protrusions 2 of the cylindrical drum 1. By making a plurality of vibration pieces 20 with the different length of sound generation pin 21 and arraying them according to the length of the sound generation pin 21 in sequence, then the sound scale such as Do, Re, Mi will be acquired.

As shown in FIG. 4, the spacers 30 are inserted between the vibration pieces 20 arrayed to form a sound scale. The spacer 30 is made of same shape and area with that of the fixing portions 22 and the spacer 30 is placed to contact the fixing portions 22 at the side surface of it. And the fixing portions 22 of the vibration pieces 20 and the spacers 30 are clamped by the clamping member firmly. Usable clamping member may be adhesive, tie rod, clamp or mounting frame. In this embodiment, a hole 31 is formed on the spacer 30 and the fixing portions 22 of the vibration piece 20, and a tie rod 31 as a clamping member 41 passes through the holes to bind the spacer 30 and the clamping member 41. The outer end of the tie rod 41 may be fixed by beating a rivet. Instead of tie rod, the spacers 30 and the fixing portions 22 of the vibration pieces 20 could be bonded in one body. Or a clamp may be used to clamp the spacers 30 and the fixing portions 22. A mounting frame having a recess to receive the spacers 30 and the fixing portions 22 could be used to hold the vibration pieces 30.

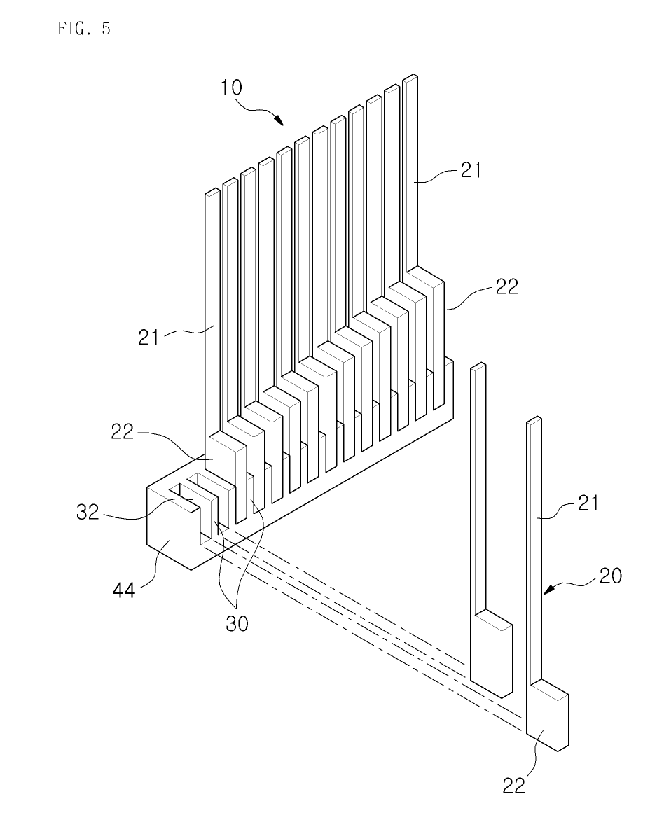

FIG. 5 shows another embodiment of the invention, wherein a supporting block 42 having spacer 30 and insert groove 32 are formed alternately is provided. The supporting block 42 is formed of rigid plastic material, and the fixing portions 22 of the vibration piece 20 is fixed by being inserted into the insert groove 32 of the supporting block 42. To hold the spacer 30 and the vibration piece 20 firmly, additional means such as adhesive or bolting or riveting may be used.

According to the invention, by making the vibration piece 20 having the sound generation pin 21 with different length separately by a lot amount and assembling them, the sound generation pin 21 with the precisely same dimension and the precisely same natural frequency can be machined and obtained at the same time to achieve more precise sound scale compared to the conventional vibration plates of music box in which the sound generation pins are formed by slitting the metal plate and cutting in different length at once, so the machining process is complicate and low in precision degree.

And according to the invention, by making the vibration piece 20 having a thin flat sound generation pin 21 and a fixing portions 22 formed at the base end of the sound generation pin 21 and having an enlarged thickness with the shape of plate by partially cutting the stack of a plurality of metal bars, a lot of vibration bar 20 could be machined to have the same dimension at the same time to achieve a precise sound scale and high productivity.

As described above, the present invention has been described with respect to particularly preferred embodiments. However, the present invention is not limited to the above embodiments, and it is possible for one who has an ordinary skill in the art to make various modifications and variations, without departing off the spirit of the present invention. For example, though the invention is described to be applied cylindrical drum type music box, it will also be applied to the disc type music box. Thus, the protective scope of the present invention is not defined within the detailed description thereof but is defined by the claims to be described later and the technical spirit of the present invention.

1. A vibration plate for music box disposed adjacent to the circumferential surface of a cylindrical drum having a plurality of protrusions on the circumferential surface of it and generating sound as it is hit by the protrusions of the cylindrical drum, wherein the vibration plate comprises of a plurality of vibration piece disposed in parallel and having a thin flat sound generation pin 21 with different length and generating sound as it is hit by the protrusion of the cylindrical drum and a fixing portions formed at the base end of the sound generation pin and having an enlarged thickness with the shape of plate, and a plurality of spacer disposed between each fixing portions of the vibration pieces to separate the vibration pieces, and a clamping member to clamp the fixing portions and the spacers.

2. A vibration plate for music box of claim 1, wherein the clamping member comprises a tie rod, and there are holes in the fixing portions of the vibration pieces and the spacers aligned with each other, and the tie rod passes through the hole.

3. A vibration plate for music box of claim 1, wherein the clamping member comprises a clamping block on which the spacers are formed in a body, and the fixing portion of the vibration pieces are inserted between the spacers.

4. A preparation method of an music box vibration plate disposed adjacent to the circumferential surface of a cylindrical drum having a plurality of protrusions on the circumferential surface of it and generating sound as it is hit by the protrusions of the cylindrical drum, wherein the method comprises of:
making the vibration piece having a thin flat sound generation pin and a fixing portions formed at the base end of the sound generation pin and having an enlarged thickness with the shape of plate by partially cutting the stack of a plurality of metal bars;
choosing a set of vibration piece having the sound generation pin with different length and arraying them to form the sound scale and inserting the spacers between each fixing portions of the vibration piece; and
clamping all the fixing portions of the vibration pieces and the spacers by use of a clamping member.
